(19) United States
(12) Patent Application Publication
(10) Pub. No.: US 2014/0301248 A1
(43) Pub. Date: Oct. 9, 2014

(54) METHODS AND APPARATUS FOR DETERMINING NETWORK SUPPORT FOR OTHER MEDIA DURING IMS EMERGENCY SESSIONS

(71) Applicant: TELEFONAKTIEBOLAGET L M ERICSSON (PUBL), Stockholm (SE)

(72) Inventors: Fredrik Lindholm, Stockholm (SE); Shabnam Sultana, Westmount (CA)

(73) Assignee: TELEFONAKTIEBOLAGET L M ERICSSON (PUBL), Stockholm (SE)

(21) Appl. No.: 14/348,706

(22) PCT Filed: Oct. 31, 2012
(86) PCT No.: PCT/EP2012/071555

§ 371 Date: Mar. 31, 2014

Related U.S. Application Data
(60) Provisional application No. 61/554,656, filed on Nov. 2, 2011.

(51) Int. Cl. H04W 4/22; H04L 29/06

(52) U.S. Cl. CPC H04W 4/22; H04L 29/06
USPC 370/259

(57) ABSTRACT

According to a first aspect there is provided a method of operating an entity within an IMS network. The method comprises, receiving a message sent by a UE, determining if media other than voice can be supported for IMS emergency sessions involving the UE,and sending a response to the UE, the response indicating if media other than voice can be supported for IMS emergency sessions involving the UE.

### TECHNICAL FIELD

The present invention relates to methods and apparatus for determining network support for other media during IMS emergency sessions.

### BACKGROUND

The IP Multimedia Subsystem (IMS) is the technology defined by the Third Generation Partnership Project (3GPP) to provide IP Multimedia services over telecommunication networks. The IMS allows a telecommunications system to offer multimedia services to user terminals (referred hereinafter as “user equipment”(UE)). For example, these services can comprise voice, video, text, chat, and combinations thereof. To do so, IMS provides key features to enrich the end-user person-to-person communication experience through the integration and interaction of services. IMS allows new rich person-to-person (client-to-client) as well as person-to-content (client-to-server) communications over an IP-based network. The IMS is able to connect to both PSTN/ISDN (Public Switched Telephone Network/Integrated Services Digital Network) as well as the Internet. In relation to an IMS, a UE may be any device, mobile or stationary, enabled to communicate by radio or any other means with the IMS via an IP-CAN, for instance but not limited to e.g. mobile phone, smart phone, sensors, meters, vehicles, household appliances, medical appliances, media players, cameras, or any type of consumer electronic device, for instance but not limited to television, radio, lighting arrangements, tablet computer, laptop, or PC.

The IMS makes use of the Session Initiation Protocol (SIP) to set up and control calls or sessions between UEs (or UEs and application servers). The Session Description Protocol (SDP), carried by SIP signalling, is used to describe and negotiate the media components of the session. Whilst SIP was created as a user-to-user protocol, IMS allows operators and service providers to control user access to services and to charge users accordingly.

FIG. 1 illustrates schematically the architecture for the IMS and its relationship to an IP-Connectivity Access Network (IP-CAN). In the IMS Core Network, Call/Session Control Functions (CSCFs) operate as SIP proxies, and interface with other entities such as Border Gateway Control Functions (BGCFs) and Media Resource Function Controllers (MRFCs) amongst others. The 3GPP architecture defines at least three types of CSCFs, and there can be multiple instances of each type of CSCF within an operator's network. A Proxy CSCF (P-CSCF) is the first point of contact within the IMS for a UE; a Serving CSCF (S-CSCF) provides services to the subscriber; an Interrogating CSCF (I-CSCF) identifies the correct S-CSCF and forwards to that S-CSCF a request received from a UE via a P-CSCF.

The Home Subscriber Server (HSS) is the main database in the IMS for storage of subscriber and service related data, including user identities, registration information, access parameters and the Initial Filter Criteria (IFC) used to trigger services. For example, the HSS provides support to the IMS nodes/functional entities implementing call and/or session functionalities in order to complete the routing/roaming procedures by solving authentication, authorization, naming/addressing resolution, location dependencies, etc. The HSS also contains functionality of a Home Location Register and Authentication Centre (HLR/AUC) to provide support to packet-switched domain entities, such as the Serving GPRS Support Node (SGSN) and Gateway GPRS Support Node (GGSN), and to circuit switched domain entities, such as the Mobile Switching Centres (MSC).

Within the service layer of the IMS network, Application Servers (ASs) are provided for implementing IMS service functionality. Application Servers provide services to end users in an IMS system, and may be connected either as end-points over the 3GPP defined Ma interface, or “linked in” by an S-CSCF over the 3GPP defined ISC interface. In the latter case, Initial Filter Criteria (IFC) are used by an S-CSCF to determine which Applications Servers should be “linked in” during a SIP Session establishment (or indeed for the purpose of any SIP method, session or non-session related). The IFCs are received by the S-CSCF from an HSS during the IMS registration procedure as part of a user's Subscriber Profile.

The IMS standards also provide support for emergency sessions. In this regard, FIG. 2 illustrates schematically the IMS network architecture for implementing IMS emergency services, which includes an Emergency CSCF (E-CSCF), a Location Retrieval Function (LRF), and an Emergency Access Transfer Function (EATF). For simplicity, not all functional components of the IMS, e.g. IBCF, MGCF and BGCF, are shown in this figure. When an emergency call is placed using a UE, it is normally routed from the P-CSCF to an E-CSCF. The E-CSCF is concerned with handling emergency sessions, and is responsible for the routing of emergency calls to the correct emergency centre or Public Safety Answering Point (PSAP). The E-CSCF has an interface to a LRF, and the E-CSCF can request the LRF to retrieve location information relating to a UE that has initiated an IMS emergency session. The E-CSCF also has an interface to an EATF. The EATF enables service continuity of IMS emergency sessions. The P-CSCF, EATF and E-CSCF are always located in the same serving network, which is the visited network when the UE is roaming.

Whilst the pre-existing IMS standards provide support for emergency sessions, these standards only consider support for emergency voice/speech calls, and do not consider how the emergency session procedures could support other media, wherein the term “other media” refers to media other than voice/speech (e.g. video, session based messaging, file transfer etc). Consequently, 3GPP is attempting to develop mechanisms to provide support for other media during emergency sessions as part of enhanced emergency services support. However, it has been recognised herein that, whilst a conventional network can indicate support of IMS emergency sessions, by sending a indication of such support to the UE either broadcasted to the UE over the radio interface or during the lower layer network attachment to the LTE network, such an indication will only relate to support for emergency voice calls, and does not necessarily indicate that the IMS network and radio network also supports other media during emergency sessions.

### SUMMARY

It is therefore an object of the present invention to provide methods and apparatus for providing accurate information regarding network support for other media during IMS emergency sessions.

According to a first aspect there is provided a method of operating an entity within an IMS network. The method comprises, receiving a message sent by a UE, determining if media other than voice can be supported for IMS emergency sessions involving the UE, and sending a response to the UE, the response indicating if media other than voice can be supported for IMS emergency sessions involving the UE.

The step of determining if media other than voice can be supported for IMS emergency sessions involving the UE can comprise one or more of determining if media other than voice is supported for IMS emergency sessions by an available PSAP, determining if media other than voice is supported for IMS emergency sessions by an access network through which the UE is accessing the IMS network, and determining if media other than voice is supported for IMS emergency sessions by entities within the IMS network that serve the UE.

In order to determine if media other than voice is supported by an available PSAP, the method may comprise determining if there is a PSAP serving an area in which the UE is currently located that supports media other than voice during IMS emergency sessions.

The method may further comprise, if it is determined that media other than voice can be supported for IMS emergency sessions involving the UE, including in the response sent to the UE an indication that media other than voice can be supported for IMS emergency sessions involving the UE. The indication that media other than voice can be supported for IMS emergency sessions involving the UE can comprise a feature tag included within a header field of the response sent to the UE. The response message sent to the UE may also include an indication of types of media that can be supported for IMS emergency sessions involving the UE.

The message received from the UE can include an indication that the UE supports media other than voice for IMS emergency sessions. The indication that the UE supports media other than voice for IMS emergency sessions can comprise a feature tag included within a header field of the message received from the UE. The message received from the UE may also include an indication of types of media that the UE supports for IMS emergency sessions.

The entity may be any of a P-CSCF and a S-CSCF, and the message received from the UE may then be a request for an IMS emergency registration. If the entity is a S-CSCF, then the step of determining if media other than voice can be supported for IMS emergency sessions can be further based on the user profile of a user of the UE. Alternatively, the entity may be any of a P-CSCF and an E-CSCF, and the message received from the UE may then be a request for establishment of an IMS emergency session. As a further alternative, the entity may be a PSAP and the message received from the UE may then be a request for establishment of an IMS emergency session.

According to a second aspect there is provided an apparatus configured to operate as an entity within an IMS network. The apparatus comprises a receiver configured to receive a message sent by a UE, a processor configured to determine if media other than voice can be supported for IMS emergency sessions involving the UE, and to generate a response indicating if media other than voice can be supported for IMS emergency sessions involving the UE, and a transmitter configured to send the response to the UE.

In order to determine if media other than voice can be supported for IMS emergency sessions involving the UE, the processor may be configured to implement one or more of determining if media other than voice is supported for IMS emergency sessions by an available PSAP, determining if media other than voice is supported for IMS emergency sessions by an access network through which the UE is accessing the IMS network, and determining if media other than voice is supported for IMS emergency sessions by entities within the IMS network that serve the UE. In order to determine if media other than voice is supported by an available PSAP, the processor may be configured to determine if there is a PSAP serving an area in which the UE is currently located that supports media other than voice during IMS emergency sessions.

The processor may be further configured to, if it is determined that media other than voice can be supported for IMS emergency sessions involving the UE, include an indication that media other than voice can be supported for IMS emergency sessions involving the UE in the response. The processor may be further configured to include a feature tag within a header field of the response as the indication that media other than voice can be supported for IMS emergency sessions involving the UE. The processor may also be configured to include in the response an indication of types of media that can be supported for IMS emergency sessions involving the UE.

The apparatus may be configured to operate as one of a P-CSCF and a S-CSCF, and the message received from the UE may be a request for an IMS emergency registration. If the apparatus configured to operate as a S-CSCF, then the processor may be further configured to make use of a user profile of a user of the UE when determining if media other than voice can be supported for IMS emergency sessions involving the UE. Alternatively, the apparatus may be configured to operate as one of a P-CSCF and an E-CSCF, and the message received from the UE may be a request for establishment of an IMS emergency session. As a further alternative, the apparatus may be configured to operate as a PSAP and the message received from the UE may be a request for establishment of an IMS emergency session.

According to a third aspect there is provided a method of operating a UE. The method comprises sending a message to an IMS network, receiving a response from an entity within the IMS network, the response indicating if media other than voice can be supported for IMS emergency sessions involving the UE, and taking the indication into account during any IMS emergency sessions involving the UE.

According to a fourth aspect there is provided a UE. The UE comprises a transmitter configured to send a message to an IMS network, a receiver configured to receive a response sent by an entity within the IMS network, the response indicating if media other than voice can be supported for IMS emergency sessions involving the UE, and a processor configured to take account of the indication during any IMS emergency sessions involving the UE.

### BRIEF DESCRIPTION OF THE DRAWINGS

Some embodiments of the present invention will now be described in detail with reference to the accompanying drawings, in which:

FIG. 1 illustrates schematically the architecture for an IMS;

FIG. 2 illustrates schematically the IMS network architecture for implementing IMS emergency services;

FIG. 3 illustrates a signalling flow diagram of an example IMS emergency registration in accordance with the methods described herein;

FIG. 4 illustrates a signalling flow diagram of an example IMS emergency session establishment in accordance with the methods described herein;

FIG. 5 illustrates schematically an embodiment of an IMS network entity configured to implement the methods described herein; and

FIG. 6 illustrates schematically an embodiment of an entity of a UE configured to implement the methods described herein.

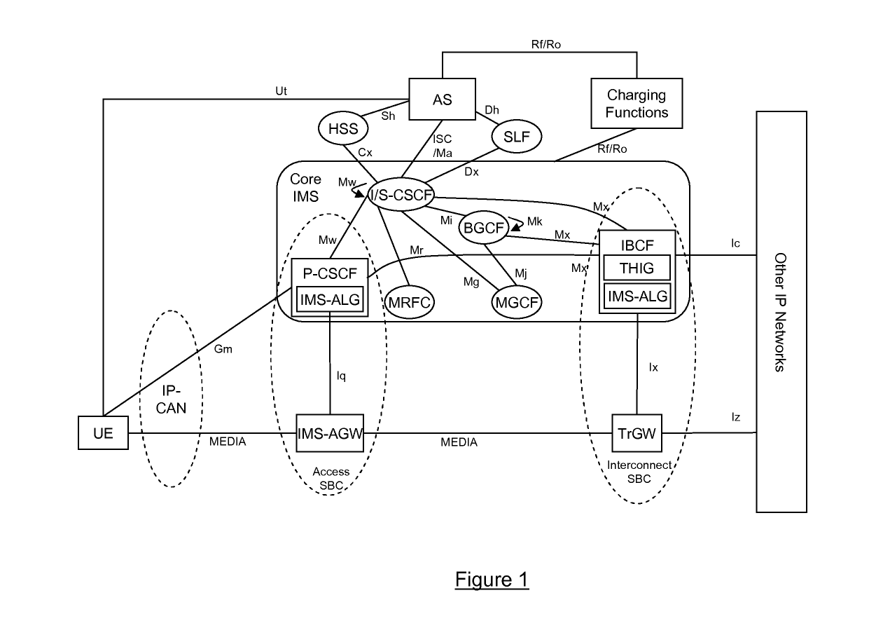

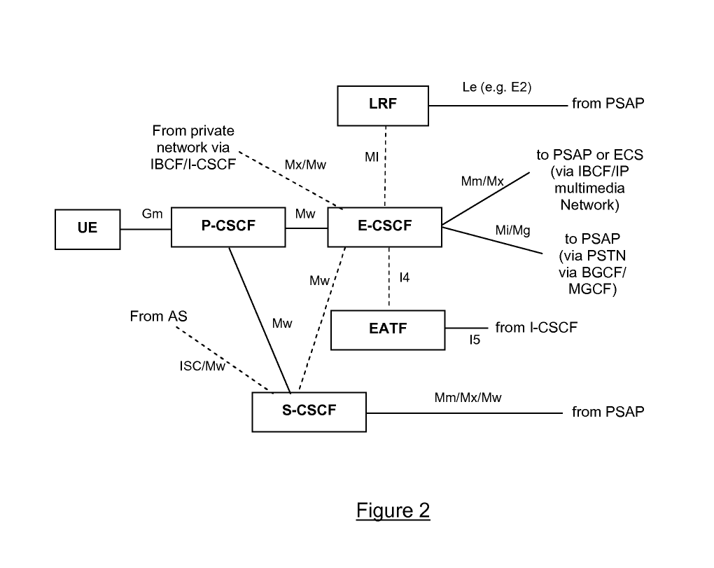

### DETAILED DESCRIPTION

In order to at least mitigate the problems identified above there will now be described methods and apparatus for providing accurate information regarding network support for other media during IMS emergency sessions. These methods involve configuring an entity within the IMS network such that, upon receiving a message sent by a UE, the IMS network entity determines if media other than voice can be supported for an IMS emergency session involving the UE. The IMS network entity is configured to then send a response to the UE, the response indicating if media other than voice can be supported for IMS emergency sessions involving the UE.

The determination made by the IMS network entity can be based on one or more of whether a PSAP serving the area in which the UE is currently located supports other media for IMS emergency sessions, whether the access network used by the UE supports other media for IMS emergency sessions, and whether the IMS network entities serving the UE and/or that would participate in an IMS emergency sessions involving the UE support other media for IMS emergency sessions. In other words, the determination is based on the support of other media for IMS emergency sessions within the area in which the UE is currently located (i.e. a geographical area or region).

Therefore, in order to determine if media other than voice can be supported for IMS emergency sessions involving the UE, the IMS network entity can be configured to determine if media other than voice is supported for IMS emergency sessions by an available PSAP. Alternatively, or in addition, the IMS network entity can be configured to determine if media other than voice is supported for IMS emergency sessions by an access network through which the UE is accessing the IMS network. Alternatively, or in addition, the IMS network entity can be configured to determine if media other than voice is supported for IMS emergency sessions by entities within the IMS network that serve the location of the UE. The IMS network entity can also be configured to ascertain the area in which the UE is currently located in order to determine if media other than voice can be supported for IMS emergency sessions involving the UE.

If the IMS network entity determines that media other than voice can be supported for IMS emergency sessions involving the UE, then the IMS network entity will include, in the response sent to the UE, an indication that media other than voice can be supported for IMS emergency sessions involving the UE. Such an indication can be provided by a feature tag included within a header field of the response sent to the UE. The IMS network entity can also be configured to include in the response an indication of types of media that can be supported for IMS emergency sessions involving the UE.

The message received from the UE may also include an indication that the UE supports media other than voice for IMS emergency sessions. This indication can be provided by a feature tag included within a header field of the message received from the UE. In addition, the message received from the UE can include an indication of types of media that the UE supports for IMS emergency sessions.

The method described herein can be implemented during an emergency registration of the UE with the IMS, such that the message received from the UE is a request for an IMS emergency registration. The entity may then be any of a Proxy Call Session Control Function (P-CSCF) and a Serving Call Session Control Function (S-CSCF) that is involved in the IMS emergency registration. If the entity is a S-CSCF, then the step of determining if media other than voice can be supported for IMS emergency sessions involving the UE can be further based upon a user profile of a user of the UE, which the S-CSCF obtains/downloads from the HSS. In addition, the method described herein can also be implemented during establishment of an IMS emergency session, such that the message received from the UE is a request for establishment of an IMS emergency session. The entity may then be any of a PSAP, a P-CSCF, and an Emergency Call Session Control Function (E-CSCF).

As a result of implementing the methods described herein, a UE will be made aware when the media other than voice can be supported for an IMS emergency session. Consequently, the UE can be configured to receive a response from an entity within the IMS network, the response indicating if media other than voice can be supported for IMS emergency sessions involving the UE; and to consider/evaluate this indication during any IMS emergency sessions involving the UE.

The methods described herein effectively provide that, when an IMS network supports media other than voice during an emergency IMS session, an IMS network entity can provide an indication of the support of other media for IMS emergency sessions involving the UE. In particular, the IMS network entity can base the determination on at least whether or not a PSAP related to that location supports other media, but can also consider/take account of whether or not the IP-CAN/RAT type via which the user is accessing the IMS network supports other media and/or whether other IMS network entities in the area of that location support other media.

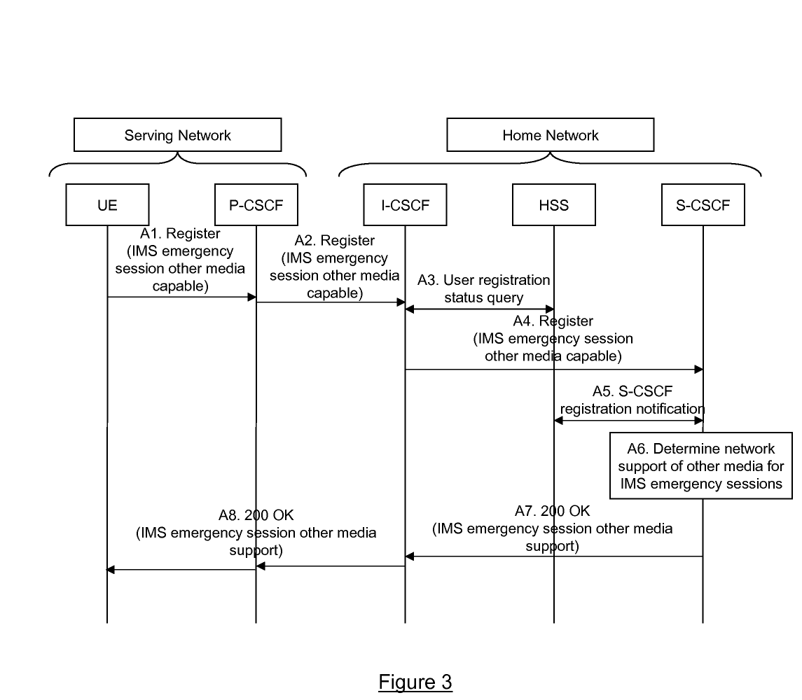

By way of example, FIG. 3 illustrates a signalling flow diagram of an IMS emergency registration during which with the methods described herein are implemented. The steps performed are as follows:

A1. A UE generates a SIP REGISTER message and includes an indication that this is an the emergency registration request. The UE also includes an indication that the UE is capable of media other than voice for IMS emergency sessions. For example, this indication could be provided by a feature tag included within a header field of the SIP REGISTER request. The indication could also specify the types of other media that the UE is capable of supporting for IMS emergency sessions. The UE sends the SIP REGISTER towards the IMS.

A2. A P-CSCF within the IMS network receives the SIP REGISTER message, and forwards the SIP REGISTER request to an I-CSCF.

A3. The I-CSCF then implements a user registration status query with the HSS, and thereby identifies a S-CSCF.

A4. The I-CSCF therefore forwards the SIP REGISTER message to the S-CSCF.

A5. The S-CSCF sends a registration notification to the HSS, and thereby obtains a user profile for a user of the UE.

A6. The S-CSCF then implements any service control, and also determines if media other than voice can be supported for IMS emergency sessions involving the UE. To do so, the S-CSCF can determine an area in which the UE is currently located, and can thereby determine if there is a PSAP serving the area where the UE is currently located that supports media other than voice during IMS emergency sessions. In addition, the S-CSCF can also determine whether or not media other than voice is supported for IMS emergency sessions by the access network through which the UE is accessing the IMS network and/or whether or not media other than voice is supported for IMS emergency sessions by entities within/serving an area in which the UE is currently located. Furthermore, the S-CSCF can optionally take into account the user profile.

A7. In this example, the S-CSCF determines that media other than voice can be supported for IMS emergency sessions involving the UE. The S-CSCF therefore generates a SIP 200 OK response and includes an indication that other media support is available for IMS emergency sessions. The S-CSCF then sends the response to the UE.

A8. The response including the indication is then routed to the UE via the I-CSCF and the P-CSCF.

As an alternative to the procedure illustrated in FIG. 3, when implemented during an IMS emergency registration, the P-CSCF could be configured to perform the determination as to whether media other than voice can be supported for IMS emergency sessions involving the UE, and can therefore include an appropriate indication in the response sent to the UE.

The indication included in the response sent to the UE could be provided by a feature tag included in a header field of the SIP 200 OK response. For example, such a feature tag could be included in the path header field of in as a Feature-Caps header field. The indication could also specify the types of other media that can be supported for IMS emergency session, such as session-based messaging, file transfer, video etc.

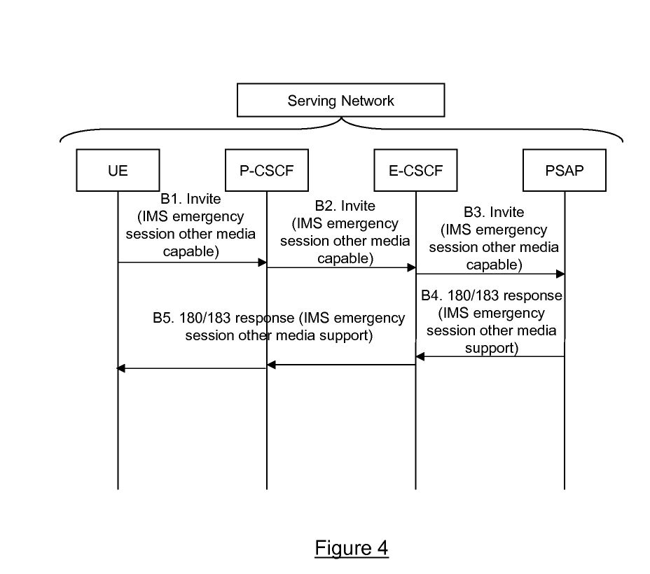

As a further example, FIG. 4 illustrates a signalling flow diagram of an IMS emergency session establishment during which with the methods described herein are implemented. The steps performed are as follows:

B1. A UE generates a SIP INVITE message and includes an indication that this is an emergency session establishment request. The UE also includes an indication that the UE is capable of media other than voice for IMS emergency sessions. The indication could also specify the types of other media that the UE is capable of supporting for IMS emergency sessions. For example, this indication could be provided by a feature tag included within a header field of the SIP INVITE request. The UE sends the SIP INVITE towards the IMS.

B2. A P-CSCF within the IMS network receives the SIP INVITE message, and detects that the SIP INVITE relates to an emergency session establishment request. Consequently, the P-CSCF selects an E-CSCF in the same network to handle the emergency session request and forwards the SIP INVITE request to the E-CSCF.

B3. Upon receiving the SIP INVITE, the E-CSCF determines the PSAP to which the request should be routed. If required, this may involve the E-CSCF retrieving location information for the UE. The E-CSCF then forwards the SIP INVITE request to the PSAP.

B4. Upon receiving the SIP INVITE, the PSAP determines if media other than voice can be supported for IMS emergency sessions involving the UE. In this example, the PSAP determines that it does support media other than voice. The PSAP therefore generates a provisional response, such as a SIP 180 Ringing or SIP 183 Session in Progress, and includes an indication that other media support is available for IMS emergency sessions. The PSAP then sends the response to the UE.

B5. The response including the indication is then routed to the UE via the E-CSCF and the P-CSCF.

As an alternative to the procedure illustrated in FIG. 4, when implemented during an IMS emergency session establishment, either of the P-CSCF and the E-CSCF could be configured to perform the determination as to whether media other than voice can be supported for IMS emergency sessions involving the UE, and can therefore include an appropriate indication in the response sent to the UE.

The indication included in the response sent to the UE could be provided by a feature tag included in a header field of either the provisional response or a final response (e.g. a SIP 200 OK). For example, such a feature tag could be included in the path header field of in as a Feature-Caps header field. The indication could also specify the types of other media that can be supported for IMS emergency session, such as session-based messaging, file transfer, video etc.

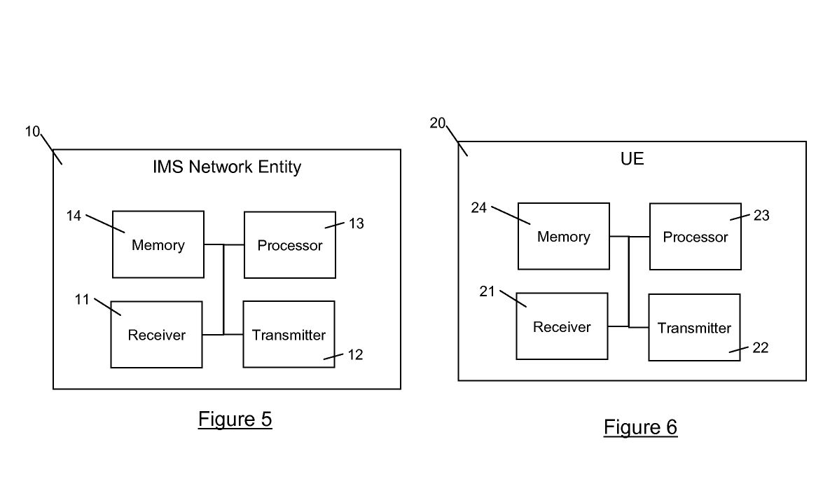

FIG. 5 illustrates schematically an embodiment of an IMS network entity 10 configured to implement the methods described above. The IMS network entity can be implemented as a combination of computer hardware and software and comprises a receiver 11, a transmitter 12, a processor 13, and a memory 14. The memory 14 stores the various programs/executable files that are implemented by the processor 13, and also provides a storage unit for any required data. The programs/executable files stored in the memory 14, and implemented by the processor 13, include but are not limited to an other media support determination unit, a message processing unit, and an emergency session support unit that are configured to implement the methods described above. As detailed above, the IMS network entity can be any of a P-CSCF, a S-CSCF, a E-CSCF and a PSAP.

FIG. 6 illustrates schematically an embodiment of an entity of a UE 20 configured to implement the methods described above. The UE 20 can be implemented as a combination of computer hardware and software and comprises a receiver 21, a transmitter 22, a processor 23, and a memory 24. The memory 24 stores the various programs/executable files that are implemented by the processor 23, and also provides a storage unit for any required data. The programs/executable files stored in the memory 24, and implemented by the processor 23, include but are not limited to a message processing unit, an emergency session support unit, and an other media support determination unit.

Although the invention has been described in terms of preferred embodiments as set forth above, it should be understood that these embodiments are illustrative only. Those skilled in the art will be able to make modifications and alternatives in view of the disclosure which are contemplated as falling within the scope of the appended claims. Each feature disclosed or illustrated in the present specification may be incorporated in the invention, whether alone or in any appropriate combination with any other feature disclosed or illustrated herein. For example, in the illustrated example signalling flow diagrams described above, only those messages and headers that are of particular relevance are shown. Those skilled in the art will be aware those messages and headers that have not been included in this illustration.

1. A method of operating an entity within an Internet Protocol (IP) Multimedia Subsystem (IMS) network, the method comprising:
receiving a message sent by a user equipment (UE);
determining whether media other than voice can be supported for IMS emergency sessions involving the UE; and
sending a response to the UE, the response indicating whether media other than voice can be supported for IMS emergency sessions involving the UE.

2. The method as claimed in claim 1, wherein the determining whether media other than voice can be supported for IMS emergency sessions involving the UE comprises any of:
determining whether media other than voice is supported for IMS emergency sessions by an available Public Safety Answering Point (PSAP);
determining whether media other than voice is supported for IMS emergency sessions by an access network through which the UE is accessing the IMS network; and
determining whether media other than voice is supported for IMS emergency sessions by entities within the IMS network that serve the UE.

3. The method as claimed in claim 2, wherein, the determining whether media other than voice is supported by an available PSAP comprises:
determining whether there is a PSAP serving an area in which the UE is currently located that supports media other than voice during IMS emergency sessions.

4. The method as claimed in claim 1, and further comprising:
responsive to determining that media other than voice can be supported for IMS emergency sessions involving the UE, including in the response sent to the UE an indication that media other than voice can be supported for IMS emergency sessions involving the UE.

5. The method as claimed in claim 4, wherein the indication that media other than voice can be supported for IMS emergency sessions involving the UE comprises a feature tag included within a header field of the response sent to the UE.

6. The method as claimed in claim 4, wherein the response sent to the UE includes an indication of types of media that can be supported for IMS emergency sessions involving the UE.

7. The method as claimed in claim 1, wherein the message received from the UE includes an indication that the UE supports media other than voice for IMS emergency sessions.

8. The method as claimed in claim 7, wherein the indication that the UE supports media other than voice for IMS emergency sessions comprises a feature tag included within a header field of the message received from the UE.

9. The method as claimed in claim 7, wherein the message received from the UE includes an indication of types of media that the UE supports for IMS emergency sessions.

10. The method as claimed in claim 1, wherein the entity is any of a Proxy Call Session Control Function (P-CSCF) and a Serving Call Session Control Function (S-CSCF), and the message received from the UE is a request for an IMS emergency registration.

11. The method as claimed in claim 10, wherein, the entity is a S-CSCF, and the determining whether media other than voice can be supported for IMS emergency sessions is based on the user profile of a user of the UE.

12. The method as claimed in claim 1, wherein the entity is any of a Proxy Call Session Control Function (P-CSCF) and an Emergency Call Session Control Function (E-CSCF), and the message received from the UE is a request for establishment of an IMS emergency session.

13. The method as claimed in claim 1, wherein the entity is a PSAP and the message received from the UE is a request for establishment of an IMS emergency session.

14. An apparatus to operate as an entity within an Internet Protocol (IP) Multimedia Subsystem (IMS) network, the apparatus comprising:
a receiver operative to receive a message sent by a UE;
a processor operative to determine whether media other than voice can be supported for IMS emergency sessions that involve the UE, and to generate a response that indicates whether media other than voice can be supported for IMS emergency sessions that involve the UE; and
a transmitter operative to send the response to the UE.

15. The apparatus as claimed in claim 14, wherein to determine that media other than voice can be supported for IMS emergency sessions that involve the UE, the processor is operative to:
determine whether media other than voice is supported for IMS emergency sessions by an available Public Safety Answering Point (PSAP); or
determine whether media other than voice is supported for IMS emergency sessions by an access network through which the UE is accesses the IMS network; or
determine whether media other than voice is supported for IMS emergency sessions by entities within the IMS network that serve the UE.

16. The apparatus as claimed in claim 15, wherein, to determine whether media other than voice is supported by an available PSAP, the processor is operative to
determine whether there is a PSAP that serves an area in which the UE is currently located that supports media other than voice during IMS emergency sessions.

17. The apparatus as claimed in claim 14, wherein responsive to media other than voice being determined to support IMS emergency sessions that involve the UE, the processor is further operative to include an indication that media other than voice can be supported for IMS emergency sessions that involve the UE in the response.

18. The apparatus as claimed in claim 17, wherein the processor is further operative to include a feature tag within a header field of the response as the indication that media other than voice can be supported for IMS emergency sessions that involve the UE.

19. The apparatus as claimed in claim 17, wherein the processor is further operative to include in the response an indication of types of media that can be supported for IMS emergency sessions that involve the UE.

20. The apparatus as claimed in claim 14, wherein the entity is any of a Proxy Call Session Control Function (P-CSCF) and a Serving Call Session Control Function (S-CSCF), and the message received from the UE is a request for an IMS emergency registration.

21. The apparatus as claimed in claim 20, wherein, the entity is a S-CSCF, and the processor is further operative to make use of a user profile of a user of the UE to determine whether media other than voice can be supported for IMS emergency sessions that involve the UE.

22. The apparatus as claimed in claim 14, wherein the entity is any of a Proxy Call Session Control Function (P-CSCF) and an Emergency Call Session Control Function (E-CSCF), and the message received from the UE is a request for establishment of an IMS emergency session.

23. The apparatus as claimed in claim 14, wherein the entity is a PSAP and the message received from the UE is a request for establishment of an IMS emergency session.

24. A method of operating a User Equipment (UE), the method comprising:
sending a message to an Internet Protocol (IP) Multimedia Subsystem (IMS) network;
receiving a response from an entity within the IMS network, the response including an indication of whether if media other than voice can be supported for IMS emergency sessions involving the UE; and
taking the indication into account during any IMS emergency sessions involving the UE.

25. A User Equipment (UE), comprising:
a transmitter operative to send a message to an IP Multimedia Subsystem (IMS) network;
a receiver operative to receive a response sent by an entity within the IMS network, the response including an indication of whether if media other than voice can be supported for IMS emergency sessions that involve the UE; and
a processor operative to take account of the indication during any IMS emergency sessions that involve the UE.
